(19) United States
(12) Patent Application Publication
(10) Pub. No.: US 2004/0162702 A1
(43) Pub. Date: Aug. 19, 2004

(54) Diet/exercise monitor

(76) Inventors: Radha K. C. Pandipati, Montgomery Village, MD (US); Venkata Rao Mulpuri, Fairfax Station, VA (US)

Correspondence Address: Radha K. C. Pandipati, 19531 Desmet Place, Montgomery Village, MD, 20886, US

(21) Appl. No.: 10/367,033

(22) Filed: Feb. 19, 2003

(51) Int. Cl. G01G 7/00

(52) U.S. Cl. 702/173

(57) ABSTRACT

This invention is related to an apparatus, which helps one to maintain one's health. The apparatus comes with unique software, which allows one to enter data about one's regular eating habits, physical activities, weight, age, height, etc by touch of a few buttons. The unique software organizes all the information, keeps track of eating patterns & physical activity, performs detailed analysis and comes up with a recommendation on what one shall eat next and on the desired physical activity for keeping good health. The stored data can be viewed in various formats, namely, tabular statements, pie-charts, etc

### CROSS-REFERENCE TO RELATED APPLICATIONS

U.S. Pat. No. 5,314,389 “Exercise Monitor” by Simon Dotan, dated May 24, 1994.

U.S. patent application Ser. No. 20020032385 “Health monitoring system” by Stephan A. Raymond, Geoffery Gordon, Daniel B. Singer, dated Mar. 14, 2002.

U.S. Pat. No. 5,516,334 “Interactive exercise monitor” by Gregory D. Easton, dated May 14, 1996.

U.S. Pat. No. 4,803,625 “Personal health monitor” by Ping W. Fu, Thomas J. Manning, dated Feb. 7, 1989.

U.S. Pat. No. 6,251,048 “Electronic exercise monitor” by Arthur H. Kaufman dated Jun. 26, 2001.

U.S. Pat. No. 6,282,441 “Health monitoring system” by Stephan A. Raymond, Geoffery Gordon, Daniel B. Singer, dated Aug. 28, 2001.

### BACKGROUND OF THE INVENTION

1. Field of the Invention

The present invention relates generally to a Diet/Exercise Monitor. This gadget helps the user to maintain his/her health by keeping track of eating patterns & physical activity.

2. Description of the Related Art

Almost everybody wonders at one time or other about how to control body weight and keep good health. Many people think, “Although I eat pizza only once a while, I do not know how I am putting on pounds”. Some of them attempt to keep track of how often and what they ate, cautiously remembering what they ate last and in the recent past. They do this by memorizing or by keeping a log of their eatings. This is quiet an involved task, which is very laborious and time consuming. After a while they loose patience and stop recording the data. There ends the plan to control/maintain weight and/or good health.

Health is the most important thing in everybody's life. What one eats and what physical activity one does influences one's health in a major way. The most important basic rule of healthier eating is “keeping track of eating habits”. Studies indicated that just keeping track of what one eats each time in the recent past helps one to choose a healthy and balanced food. Also, statistical data indicates people loosing weight and becoming healthier by keeping track of what they eat and what physical activity they perform on a regular basis. So keeping track of the two items, (i) what food was consumed and (ii) how much physical exercise has been done, plays an important role in achieving and maintaining good health.

Although many people want to keep track of what they eat, they find it difficult to maintain bookkeeping. Just think of the work involved in bookkeeping. Nevertheless, keeping track of what one eats is of enormous value for one's health. Similarly keeping track of physical activity in the recent past also helps to attain and retain good health. The gadget of this invention helps one keeping track of food consumption and physical exercise activities in an easy way.

It is more difficult to keep track of diet when eating out than when eating at home. One does not have as much control over the salt, butter, oil, etc, as in his/her own kitchen. Beyond that, restaurants offer some tasty treats, not easily made at home, which wet one's appetite. For these reasons, it is important to monitor how often one eats out. If simply eating healthier (by cutting down on fats, cholesterol, salt, etc) is the goal and one eats out frequently, then one must monitor key nutritional elements like saturated fat, cholesterol, sodium, etc. Also one must establish the frequency of eating out that fits his/her lifestyle. Thus, for healthier eating out, one should a) keep track of eating-out frequency, b) choose restaurants with care, c) make savvy menu choices, d) hold the line on fat, saturated fat, salt etc. and e) practice portion control. The gadget of this invention helps in achieving all the above. First it keeps track of how many times one ate out, how many times one ate out at the same restaurant, how many times one ate the same food, etc. in the last few days or last week or last month. The gadget has the generic nutritional information for most of the items served at restaurants, so one can make intelligent menu choices to hold the line on fat, sodium, etc. and to control the intake portions. Additionally, the gadget even comes up with a recommendation of what the menu should be for one's next meal if one desires so. This advice is based on one's eating data entered into the gadget over a specific time period. Based on the data entered over a specific time interval the gadget recommends one of the item the person likes to eat and the quantity also to satisfy a budgeted calorie or nutrient (salt, cholesterol etc.) intake.

Once a person has eaten and begun to digest the food consumed, his/her body only knows two ways of dealing with the new calories he/she has taken in. They will be used to keep the person going or store them as fat in his/her body. Gadget of this invention keeps track of calorie in-take, and cautiously recommends a suitable menu for the next and future meals as it is not good to store what one ate as fat beyond a certain limit. Weight is a serious problem in the United States. Approximately 80 million Americans are overweight: half of those are considered to be obese and 11 million are considered severely obese. These figures are a cause for concern because obesity is associated with numerous health problems such as high blood pressure, coronary artery disease, abnormally high levels of blood fats and adult-onset diabetes. Being over-weight can also cause psychological problems. In search of a miraculous solution to the weight problems, many people try everything and anything—with little success. The gadget of this invention will be of help to those attempting to maintain good health by diet and/or physical exercise.

Weight maintenance involves maintaining equilibrium between calories consumed and calories burned. Therefore, the number of calories one consumes and his/her level of physical activity will determine if one maintains, gains, or loses weight. This sounds simple, but in practice, it proves quite difficult for many people to control their weight. In addition, what one consumes should be a well-balanced, nutritious diet in appropriate amounts. Thus, our gadget helps to maintain one's weight as it warns one if he/she has consumed too many calories or not burning regular or extra planned calories.

Now, with this invention, one can stop worrying about the difficulties described above. One can simply carry the gadget in pocket and enter each time he/she eats. Instantaneously the software organizes all the information into a file that can be viewed in various formats. It's fast, easy, and convenient to enter, maintain and organize the data. One can now use the gadget, to control his/her eating habits. Similarly one can enter his/her exercise information. The gadget allows one to easily keep track of his/her exercise activity, which can be motivate him/her to become regular in exercising. This gadget helps to maintain a balance between food in-take and calories burned on a continuous basis. The gadget can also self correct its' built-in food and physical exercise information based on the data supplied to the gadget.

Apparatus/gadget of this invention provides an easy means to keep track of what one eats. Just take out the apparatus from pocket, turn it on, and select menu. It displays various types of foods, one selects the item he/she ate and enters its quantity. A menu also displays various types of physical exercises. One selects the physical exercise he/she has done and enters the time duration of the exercise. That's it. A version of the gadget also has a built-in scanner to scan the UPC symbols of the food items. Just press the UPC symbol button, scan the beam across the UPC symbol on the restaurant menu or a food package. The gadget contains a software module that contains nutritional data for each of the UPC symbols. In future, it is expected that the restaurant menus will have the UPC symbols for all the food items on the menu. That is it. The gadget uses the stored nutritional information for the item entered (or UPC symbol that is scanned) or calories burned if the entry was about physical exercise and instantaneously modifies the files, analyses the data and comes up with new recommendation for the next eating or physical activity.

A thorough patent search resulted in the following related patents but none of them teach or proposed a gadget with features same as in this invention. For example, the U.S. Pat. No. 5,314,389 entitled “Exercise Monitor” deals with a device, which provides an exercising person information at any desired period of time about his/her pulse rate at that instant. The information is given as audio information.

The U.S. patent application Ser. No., 20020032385, entitled “Health monitoring system” deals with a health monitoring system which tracks the state of health of a patient. It compiles a chronological health history of the patient, uses a multi-parametric monitor that periodically and automatically measures and records a plurality of physiological data from sensors in contact with the patient's body.

Other U.S. Pat. No. 5,516,334 entitled “Interactive exercise monitor” deals with an interactive exercise monitor. It computes and displays time, distance, pace, and energy expended by a user who is performing a repetitive workout around a predetermined course.

Another U.S. Pat. No. 4,803,625 entitled “Personal health monitor” deals with a personal health monitor, which includes sensors for measuring patient weight, temperature, blood pressure, and ECG waveform. The monitor is coupled to a central unit via modems and includes a computer which is programmed: to prompt a patient to take prescribed medication at prescribed times, to activate the sensors to measure prescribed health parameters, and to supply answers to selected questions.

The U.S. Pat. No. 6,251,048 entitled “Electronic exercise monitor” deals with monitoring the repetitive performance of an exercise and for providing an individual with the motivation and encouragement needed to complete an exercise routine.

Yet another U.S. Pat. No. 6,282,441 entitled “Health monitoring system” deals with a portable monitor having the capability to construct, manage, and store a detailed, multi-parametric record of an individual's physiological well-being that can be used for tracking and assessing general health over days, months, and years.

The prior art references describe gadgets with applicability to various purposes other than the purpose the present invention is intended for.

### SUMMARY OF THE INVENTION

This invention deals with an apparatus comprising: a means to keep track of food items consumed by a person (user); and a means to keep track of physical exercises performed by the person (user). In a feature of this invention, the apparatus is further comprising: a means to enter data on date, food items consumed, amount of each food item consumed, caloric and nutrient values of the food items consumed; physical exercises performed, duration of each physical exercise, calories burned in each exercise; sex, age, height, weight and body frame of the person (user); a means to process the data entered over a desired time period; a means to present the processed data in various formats like tables, bar-graphs and pie-charts.

In an aspect of the invention, the means to enter data is a stylus or a keypad or a UPC symbol scanner connected to the apparatus or a voice command or a combination there of. In yet another aspect of the invention, the apparatus is further comprising a built-in data base: on caloric and nutrient values of food items served in restaurants, sold in stores and prepared at home; on calorie burning rate of physical exercises; on desirable weights for different height and body-frame combinations, on percentage of U.S. recommended daily allowances, on various diets, such as, Pritikin diet, low -fat diet, 600-calorie diet, and 1000-calorie diet; on nutrient calorie ratios of common food items consumed; nutrient comparison charts for various food items; and on answers to frequently asked questions on diet and physical exercise.

In another feature of the invention, the apparatus is further comprising means of automatically calculating the food items consumed into equivalent calories or amounts of various nutrients or both, and individual percentage caloric value of each nutrient in the food consumed with respect to total caloric value, and physical exercises performed into equivalent calories burned.

In an yet another feature of the invention, the apparatus is further comprising means to perform calorie balance analysis or nutrient content balance analysis or both by comparing the calculated value of the calories or the nutrient in the food consumed with a budgeted calorie in-take or the nutrient in-take prescribed by a health professional or calculated by the apparatus itself based on attributes such as the person's sex, age, height, weight, and body-frame.

In an aspect of the invention the apparatus is further comprising a means to come-up with a dietary or a physical exercise recommendation if the calorie balance or the nutrient balance or both is/are positive or negative. In yet another aspect of the invention, the apparatus further has a means to self-correct the built-in database based on the food items consumed, physical exercise, and user weight data entered continually over a specified time period.

In a feature of the invention the apparatus is further comprising a means to get connected to a computer in order to dial-up to a web-site to upgrade the built-in data base and software, to send selected information electronically to a health professional if desired or to print the data. In yet another feature of the invention, the device is further comprising alerting features like audible alarm or beeper or vibration or a combination of these features: to remind the person (user) over a specified interval to enter the data on food items consumed and physical exercises performed, and also to alert the person whenever the calories in-take or the nutrient in-take exceed their budgeted values.

In an aspect of this invention, the apparatus is further comprising a means to present information on type of the food items consumed or type of the physical exercise performed or both in the past over a specified period of interest including the date, description of food items consumed, the amount of each food item consumed, equivalent calorie amount of the food items, amount of each nutrient in the food consumed, description of physical exercise performed, duration of exercise, and calories burned.

In yet another aspect of the invention the apparatus is further comprising means to keep track of food items consumed and physical exercises performed by more than one person. In a feature of this invention the apparatus is further comprising means to get integrated with a calculator, a telephone, an organizer, a radio, or a CD/cassette player.

In yet another feature of this invention, the apparatus is further comprising: a means of comparing physical exercise calories burned with a budgeted physical exercise calories burnout; and a means to come up with a physical exercise recommendation if exercise calories balance is positive.

In yet another feature of this invention, the apparatus is further comprising: a display to facilitate inputting of data, viewing of processed data and databases in the gadget.

These and other features of the present invention will be readily apparent to those of ordinary skill in the art upon review of the detailed description that follows.

### BRIEF DESCRIPTION OF THE DRAWINGS

The invention, together with its features and the advantages thereof, may best be understood by reference to the following detailed description taken in conjunction with the accompanying drawings of which:

FIG. 1 illustrates a typical front view of the Diet/Exercise Monitor (gadget);

FIG. 2 illustrates typical screen view as seen upon turning on the gadget;

FIGS. 3a through 3i illustrate typical various views of the screen in operating the gadget upon clicking the “File” menu;

FIG. 4 illustrates typical screen view as seen upon clicking the “Edit” menu of the gadget;

FIGS. 5a through 5c illustrate typical various views of the screen in the operating the gadget upon clicking the “Actions” menu; and

FIG. 6 illustrates typical screen view as seen upon clicking the “Help” menu of the gadget.

### DETAILED DESCRIPTION OF THE PREFERRED EMBODIMENTS

The present invention will now be described more fully hereinafter with reference to the accompanying drawings, in which preferred embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art.

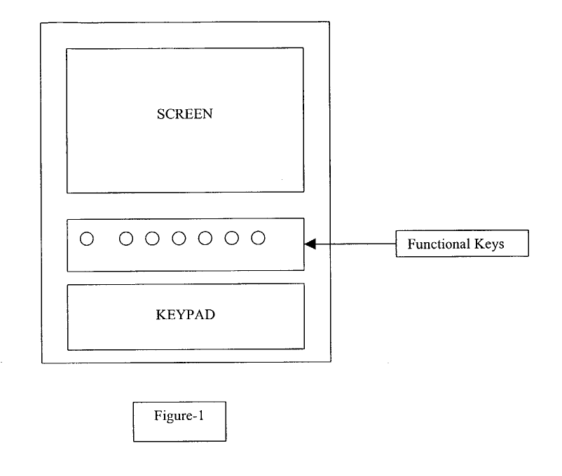

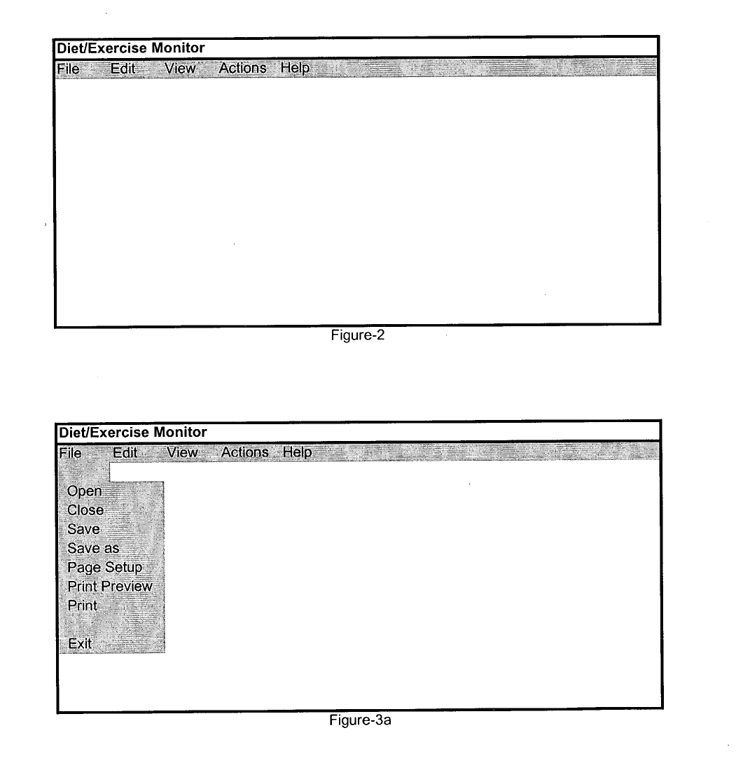

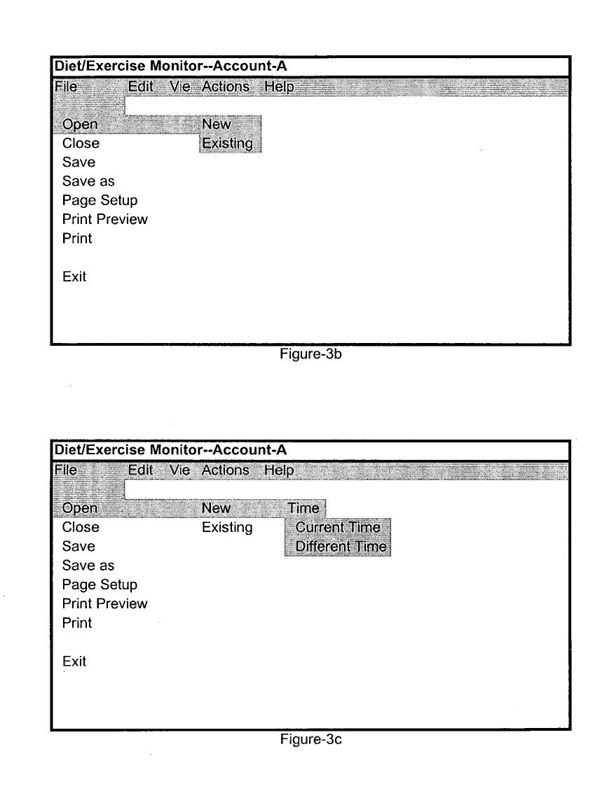

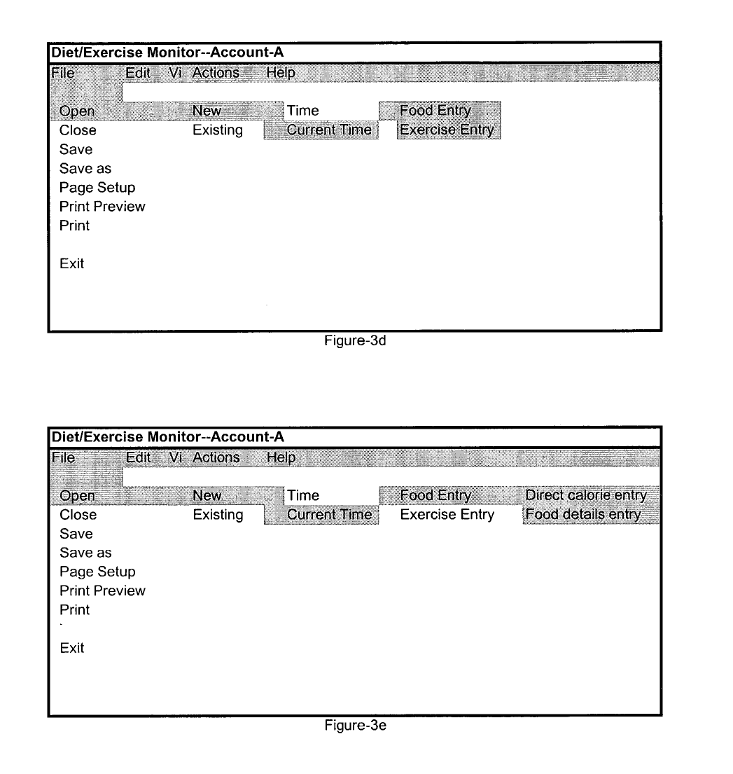

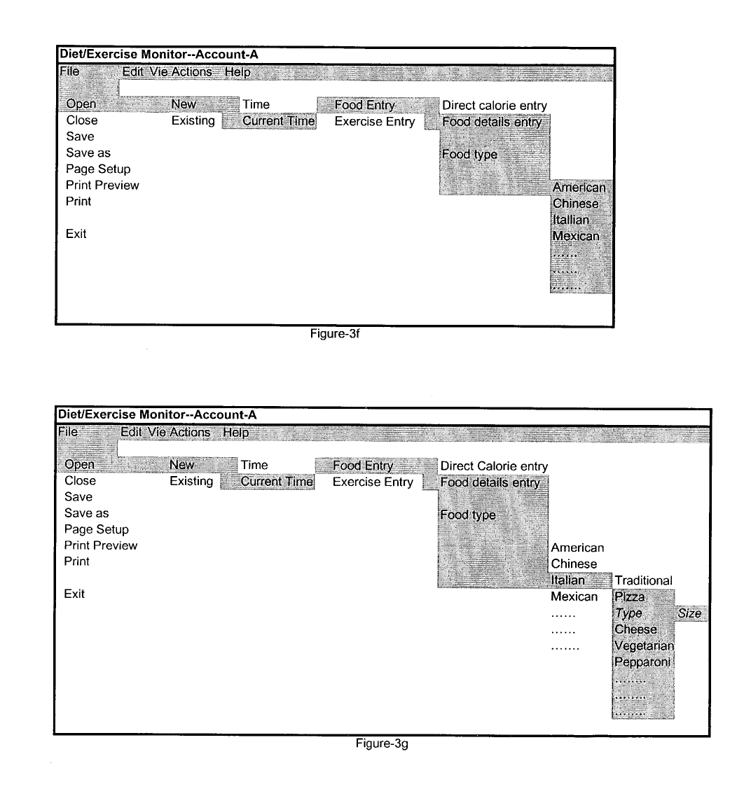

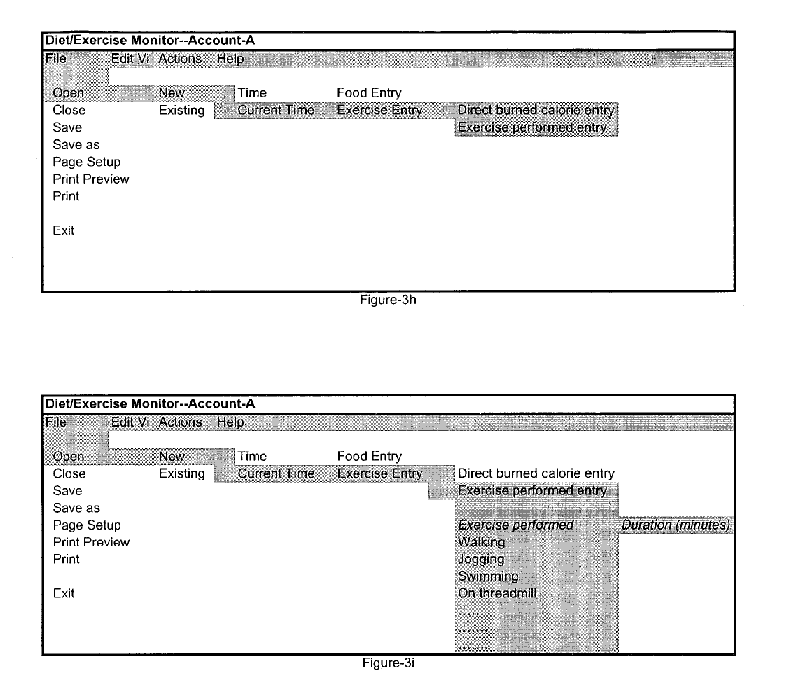

The apparatus/gadget of this invention, in physical appearance, as shown in FIG. 1, is similar to a Personal Data Assistant (PDA). It has a large screen, functional keys and a keypad; and comes with an unique software, which allows one to enter data on one's eatings, physical activities, weight, age, height, body frame etc. Data can be entered by using a stylus, similar to that of a PDA. One can write freehand and edit or use the screen touch keyboard to enter the alphanumerical data or use the pictorial format to enter the data where various items are depicted pictorially. The apparatus/gadget may also have a keypad to select functions and enter data. The gadget may also have a scanner to scan the UPC symbols. In the pictorial format, the gadget has another unique way of entering the data by opening/clicking the file tab as shown in FIG. 2. This opens up a number of menus, sub-menus, and sub-sub-menus using which date, time, the item and its quantity can be entered. FIGS. 3a through 3i illustrate various typical views of the screen of the gadget upon clicking “File” menu and its sub-menus and sub-sub-menus. Also, it allows one to edit what has been entered. FIG. 4 illustrates typical screen view upon clicking the “Edit” menu of the gadget. It lists most of the items from the menus of all the popular national chain restaurants. If what one wants to enter does not fall under this category, then one can use the stored generic list (see Appendix-E) for that specific food item. Clicking of the file tab also shows physical exercise tab, clicking which opens up a number of physical exercises. This gadget also has a provision to directly enter calories of food eaten or calories burned by exercise. Thus, this gadget allows one to enter a) what and how much he/she ate each time and what time of the day, and b) the exercise performed and its duration each time.

A version of the gadget/apparatus will have a provision to operate the gadget by voice (but for turning-on the unit) and it allows one to enter data by voice command, to display the inputted/processed data on the screen, to display various databases, etc. Further it has a mode, upon its activation, will announce on gadget's speaker key analysis outcomes or recommendations, etc.

The apparatus has hardware, which is programmable and processes and stores data. It means the hardware comprises a data input/output interface unit, buffer stages, a controller part, a processor part, and a memory/storage part. The hardware may comprise one or more semiconductor chips. The apparatus also has a display and data input means. The apparatus may also have a speaker. The apparatus is powered by a battery.

The unique software consists of (a) algorithms for performing various analyses, like, “Calorie Balance”, etc, and (b) voluminous data or database, which is used in performing various analyses. The database can also be accessed by the user independently. The gadget comes with two options of the software, namely, basic and advanced.

Basic Option

In the basic option, the gadget compiles all the data entered. The software converts the entered food and its quantity into calories and/or amounts of various nutrients, namely, fat, protein, carbohydrates, calcium, sodium, cholesterol, etc. The basic option also computes the total calorie intake for the day up to that time of the day. It also computes the total intake of each nutrient for the day up to that time of the day. The compiled and processed data is displayed on screen in various formats, like, tables, bar-graphs, pie-charts, etc.

For example, if one wants to know what he/she consumed each day during the last week, then the data will be displayed on screen in a tabular form with the following column headings:

| | | | |
|---|---|---|---|
| Date | Food Item ate | Total Calories | Budget calories |
| | & amount | for the day | for the day |

The gadget has a provision to enter budgeted calories for a day or the software comes up with a budget based upon the age, height, weight & other data provided to the gadget for that person. The gadget also has a provision to enter the budgeted amount of a nutrient like sodium, fat, cholesterol etc. for a day. Upon each entry the gadget computes the total intake of calories and/or each nutrient for the day up to that time of the day and gives the balance of the total calorie intake and/or a total nutrient intake against the budgeted amount for the day.

One can also find out, for example, when he/she ate a particular type of food item, let us say, pizza. Upon entering the name of the food item, say pizza, and the period of interest, then the apparatus lists chronologically each time one ate pizza, what kind and how much one ate, and the data will be displayed on screen in a tabular form with the following column headings:

| | | | | |
|---|---|---|---|---|
| Type of food | Food Description | Amount ate | Date | Equivalent |
| item | | | | calories |

Similarly if one wants to know what food item(s) contributed to a particular nutrient, like, sodium or cholesterol, etc, then the data will be displayed on screen in a tabular form with the following column headings, upon entering the nutrients name and the period of interest.

| | | | |
|---|---|---|---|
| Type of Nutrient | Food that | Amount of the | Date |
| | contributed | nutrient | |

For example, a person with high blood pressure, upon knowing what food items contributed to high sodium, can modify his/her future diet habits.

Alternately, if one would like to know all the exercises he/she performed during the last week along with the calories burned, then the data will be displayed on screen in a tabular form with the following column headings upon entering the period of interest.

| | | | | |
|---|---|---|---|---|
| Date | Exercise | Duration of | Calories | Total Calories |
| | Performed | Exercise | | Burned for the |
| | | | | Week up to |
| | | | | that Time |

A user of this gadget will also be able to check, at any time, the balance of calorie/nutrient intake available in his/her total budget for a specific time period (a day or a week or longer as the case may be). Any feature of the gadget described here for a particular time interval (for example a day) is also applicable for other time intervals (for example for a week or a month or longer).

The gadget also has a provision that allows one to create his/her own tabular data of the parameters of their interest. For example, if one wants to know on a particular day what he/she ate and what exercise he/she performed, then he/she can retrieve the data as shown below:

| | | | |
|---|---|---|---|
| Date | Food Item Ate | Exercise performed | Calories |
| | | | intake(+) |
| | | | /burned (−) |

Advanced Option

In the advanced option, the software contains the necessary algorithms for performing various analyses, like, “Calorie balance” using the entered data. The entered data is converted into nutritional information using the voluminous database. From the personal data, namely, height, age, sex, body frame, etc. the gadget comes up with a recommended calorie budget per day. One can edit or override this budget proactively, which allows an user to input a doctor or a dietician recommended calorie budget. The software performs the calorie balance analysis each time one enters the type and quantity of a food item that has been consumed or enters an exercise that has been performed, and comes-up with a recommendation if it determines there is a negative or a positive balance. For example, for a positive calorie balance it may suggest some food items and their amounts that are appropriate to balance the calorie intake with the budget. The suggested food items will be among the items entered by the user to the gadget as food intake over a specified time period like a week or a month or longer. It means the gadget will not recommend a food item that falls outside the group of food items normally consumed by the user. In case of a negative calorie balance the gadget recommends an exercise with its' time duration in order to burn-off the excess calories. The exercise recommended by the gadget is also among the normal exercises performed by the user and entered as a data into the gadget by the user. If the balance is related to a nutrient like sodium or cholesterol or saturated fat etc. and the balance is negative the gadget immediately brings it to the attention of the user by a blip sound or a continuous alarm or any other signal that gets the user's attention. The gadget also suggests some food items and the amounts that are appropriate for the rest of the day in order to minimize further intake increase of that particular nutrient for the day. It may also suggest some changes in food habits to maintain a balance over a two day period or longer.

Let us consider an example

A male of 35 years old of medium body frame, 5′8″ tall and is an office worker. Following is the simple calorie balance analysis:

| | | |
|---|---|---|
| In-take = | +2400 | Calories |
| Metabolism = | −1300 | Calories |
| Office/Household work/Exercise = | −1100 | Calories |
| Net = | 0 | Calories |

For example, the calorie balance analysis for this person, say, for the entire month is same as above for each of the days, then the weight of that person is not expected to change. On the basis of calories, there is no recommendation except to recommend that the person need to continue the same lifestyle. On the other hand, let us say on a holiday when that person has not planned any activity and even eats more as he/she stays home most of the day. Then for that day let us say the calorie balance analysis looks like this:

| | | |
|---|---|---|
| In-take = | +2800 | Calories |
| Metabolism = | −1300 | Calories |
| Office/Household work/Exercise = | −700 | Calories |
| Net = | +800 | Calories |

Now the gadget comes up with a recommendation, a) that the person has to burn-off those excess calories by doing some extra physical exercise over the next few days, or b) the normal intake of 2400 calories need to be lowered, perhaps by 200 calories per day for the next four days. The gadget may also suggest what food item from the normal daily food item consumption needs to be cut for those four days to compensate for the extra calories consumed on a holiday. From the daily food consumption data entered by the user, which is stored in the gadget, the gadget can recognize the food items consumed by the user on a normal day with close to zero calorie balance. If the daily calorie balance is positive over a period of more than one day then the gadget keeps showing the excess calories accumulated over the last two days or more and keeps coming up with recommendations as explained above.

Alternately, that person over a holiday plans to clean up his/her yard, which is labor intensive, and wants to eat out. Let us say if the calories balance analysis just before that person goes out for dining looks like this:

| | | |
|---|---|---|
| In-take = | +1200 | Calories |
| Metabolism = | −1300 | Calories |
| Office/Household work/Exercise = | −1600 | Calories |
| Net = | −1700 | Calories |

That person can go out for a 1700-calorie dinner.

The analysis and the recommendation become more accurate as the gadget is used for long periods, namely over months. Periodic entering of one's weight (and height if it applies) allows, the unique software to self-correct user's body's metabolism rate and to come up with even better (accurate) recommendations. Let us consider again the example that was considered above, namely, a male of 35 years old of medium body frame, 5′8″ tall and is an office worker. Following is the simple calorie balance analysis:

| | | |
|---|---|---|
| In-take = | +2400 | Calories |
| Metabolism = | −1300 | Calories |
| Office/Household work/Exercise = | −1100 | Calories |
| Net = | 0 | Calories |

For example, the calorie balance analysis for this person, say, for the entire month is same as above for each of the days, then the weight of that person is not expected to change. However, over a period of three months the weight of the person in this example has increased by 5% and he entered the same into the gadget. Having ascertained that intake and burned calories in doing office/Household work are correct, the gadget modifies the metabolism calories automatically. Then the calorie balance analysis will be as below:

| | | |
|---|---|---|
| In-take = | +2400 | Calories |
| Metabolism = | −11OO | Calories |
| Office/ Household work/Exercise = | −1100 | Calories |
| Net = | +200 | Calories |

Under these circumstances, the gadget's recommendation is to cut down intake calories or perform some (extra) exercise to burn-off the extra 200 calories.

The apparatus of this invention further has a means of comparing physical exercise calories burned with a budgeted physical exercise calories burnout. It can also come up with a recommended physical exercise if exercise calories balance is positive.

The gadget also has a provision to hot-sync and to dial up a web-site dedicated to the use of this gadget to upgrade all of its software and database.

In addition to a diet that is low in fats, cholesterol, and sugars and high in good starches and fiber, one needs a balanced diet for getting all the vitamins and minerals needed for maintaining proper nutrition and good health. The calorie balance analysis results can also be viewed to show all nutrients, namely, fat, protein, carbohydrates, etc. consumed and their contribution to the total calorie intake. To illustrate, let us consider that a person used 3.5 ounces of tuna in his/her salad for lunch, then he/she would have used up a good part (let us say about 100 calories) of his/her protein budget for the day. Let us say he/she consumes about 2200 calories daily. The upper recommended calorie limit for protein intake is 13% (as mentioned by USRDA) of 2200 calories, that is 286 protein calories. Since the person ate 100 protein calories in his/her tuna salad made of 3.5 ounces of tuna, the advanced version will tell the person that he/she is left with a maximum of 186 protein calories for the day to be obtained from all other food sources. Thus the advanced version not only keeps track of the total calorie intake, it also tracks the percentage contribution of different nutrients like proteins, fats, carbohydrates, sugars etc. to the total calorie intake.

Databases in the Gadget

The software database contains data related to diets and physical exercises including but not limited to the following:

a) a table of “Desirable Weights for Men and Women based on height and body-frame (height versus weight for three different body-frames, namely; small, medium, and large);

b) Nutritional data of all items served at various restaurants and food items sold at various national and international stores. It also includes a generic table for various international food items for a given quantity. The food items include solids and liquids;

c) a database that links the UPC symbols of the products to their nutritional information. The familiar UPC bar code symbol provides the information about the product, namely who is the manufacturer, what is the product and how much it contains in that package. Our unique software has the information about the nutritional value of each product corresponding to each UPC symbol of a restaurant menu or a food package.

d) Percentage of U.S. Recommended Daily Allowances (U.S. RDA). Human bodies require considerably more than pure calories in order to operate at peak effectiveness; bodies also require all the additives supplied by key nutrients such as vitamins and minerals. Therefore, when one fuels up he/she must do so with eye toward getting all the nutrients he/she needs. The official list of what the best scientific research thinks humans need to consume is contained in the U.S. Recommended Daily Allowances, frequently known as U.S.RDA or just RDA.

e) Various diets, like, Pritikin diet, low-fat-diet, 600-Calorie Diet including Food Groups & Sample Menus for three days, 1000-Calorie Diet including Food Groups & Sample Menus for three days, Moderate calorie grocery store food programs, etc.

f) Description on how to compute food calories. This is derived from the most authoritative handbook for computing food calories, “Composition of Foods”, Handbook No. 8, issued by the United States Department of Agriculture.

g) A Table of Caloric (fat, protein, and carbohydrates) ratios of common foods. This table will make one to be aware of what each food offers with respect to fat, protein, and carbohydrates so one can choose what to eat and what not to eat.

h) Various data, like, Fat and Cholesterol Comparison Charts for meats, poultry, fish & shellfish, Diary & egg products, frozen desserts, breads, cereals, pasta, and dried peas and beans, sweets & snacks, etc.

The first step in eating right is buying right. Thus, the database in the gadget of this invention provides a guide to choosing low-saturated fat, low-cholesterol foods.

The database in our gadget also provides answers to frequently asked questions on diet and exercise. Answers can be obtained by clicking on an appropriate question in the list. Here are some of the examples:

a) I am following the diet but don't have enough energy. Could I be eating too little of certain foods?

b) What salt does?

c) What is an aerobic exercise?

d) What is the proper heart rate for aerobic exercise?

e) Why exercise is important?

Exercise is an important ingredient of healthier and happier living. Weight loss diets are all structured so that one consumes fewer calories than he/she burns, and while this process alone will result in weight loss, the kind of weight being lost is significant. This is because, faced with fewer calories coming in as food, one's body turns first to stored carbohydrates (glycogen) for energy, and as a second choice burns off the protein that makes up our lean muscle mass. It is only as a third choice that fat is metabolized. On the other hand, good aerobic exercise gets the oxygen into the body's cells, which has the effect of directly metabolizing stored fat. One other quirk of our human metabolism is that the greater the percentage of our body mass is muscle mass, the higher our metabolism. The bottom line is that regular exercise is probably the single most effective way to lose weight and if that exercise is aerobic, one gets the extra benefit of a direct health dividend to his/her cardiovascular system because he/she looses fat weight. The database in the gadget provides this kind of information at the click of an appropriate button. The software database in our gadget also contains various physical exercises related information, namely, a) calories burned per minute versus exercise activity, b) various exercise equipment, etc.

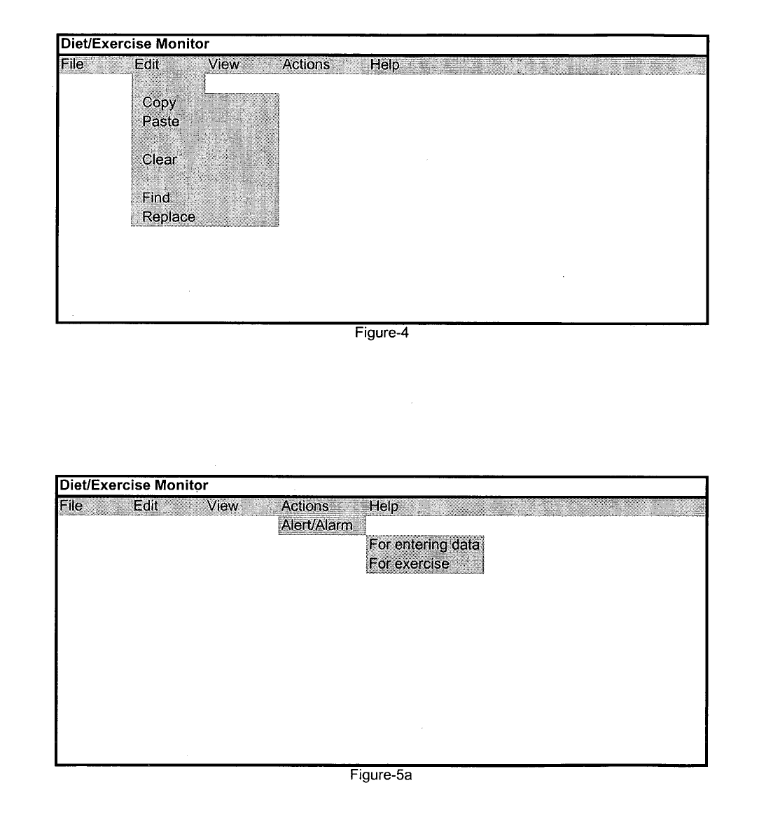

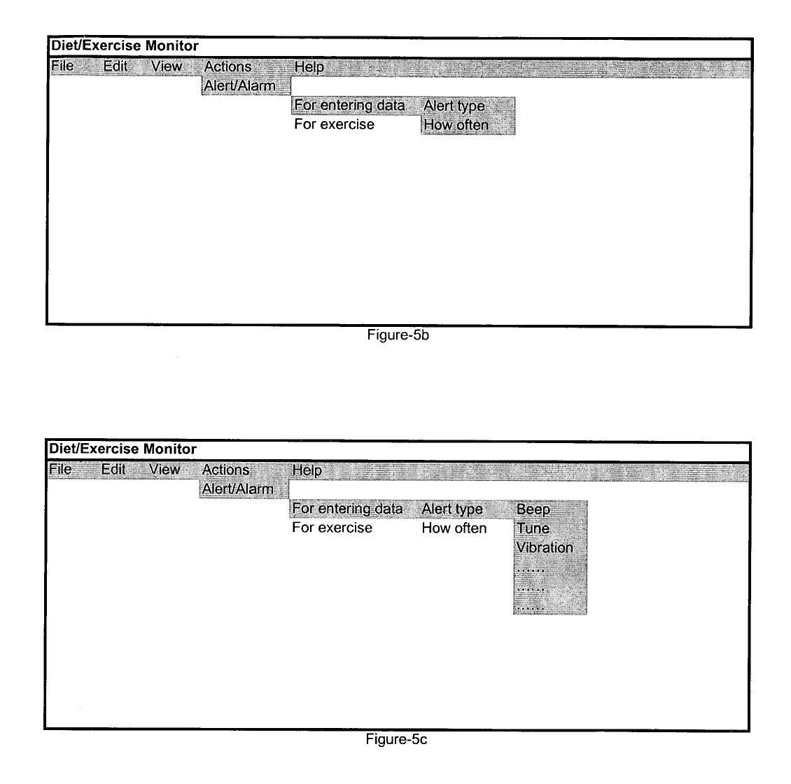

To be more effective, one needs to enter the data regularly. The gadget also has alerting features like audible alarm, beep, tune or vibration to remind one to enter data at the set intervals as desired by the user. This alert can be once per day or two times per day or three times per day or whatever way one wants. The gadget also alerts the user by an alarm signal if the consumed calories or the amount of consumption of a particular pre-selected nutrient exceeds the budgeted value. FIGS. 5a through 5c illustrate typical various views of the screen upon clicking the “Actions” menu.

This gadget is very useful for diabetic and cardiovascular disease patients. This gadget has a provision to enter customized calorie nutrient (saturated and/or unsaturated fat, proteins, carbohydrates, calcium, etc) budget and/or type of nutrient per day or week budget prescribed by a doctor or a dietician. For example, for a person with diabetes, the doctor or dietician may suggest a specified total calorie intake coupled with limits on specific nutrients. Similarly a person with high blood pressure may have to watch for not only the total amount of calorie intake but also for sodium intake. The gadget allows one to check the balance remaining for that day, in each category, before and after each entry. This gadget will be of enormous use for the people with high blood pressure, diabetes, and cardiovascular disease and for others who are under rigid dieting regiments prescribed by a doctor or a dietician.

The “Help” menu of the gadget provides an index to a number of topics related to starting from how to use the gadget, entering the data, etc. FIG. 6 illustrates a typical screen view upon clicking the “Help” menu.

This gadget also comprises a provision to connect it to a computer, to send the desired information to a health professional electronically or to print the data.

Other conveniences like a calculator, a telephone, an organizer, etc may also be integrated with its' health use in some versions of the gadget, for convenience, so that a person need not carry too many gadgets in his/her pocket.

The apparatus described previously can also embed other functions such as a conventional PDA. This apparatus can also house one or a combination of items like, a CD player, a walkman, a radio, a cell-phone, in it so it can serve multipurpose.

This gadget also has a provision to enter data of more than one person with individual separate folder for each person, i.e., the system has enough memory to store the data of several people with different ID numbers over a long period of time.

Thus, by using the gadget of this invention, described above, one can easily control and maintain his/her eating habits, exercise routine and become healthier and happier. While the invention is susceptible to various modifications and alternative forms, specific embodiments have been shown by way of example herein. However, it should be understood that the invention is not limited to the particular examples disclosed herein. Rather, the invention covers all modifications, equivalents, and alternatives falling within the spirit and scope of the invention as defined in the appended claims.

Appendix-A: Generic list of a food item

Example=Chicken

Barbecued Chicken

Grilled Chicken

Fried Chicken

Steamed Chicken

Etc

What is claimed is:

1. An apparatus comprising:
a means to keep track of food items consumed by a person (user); and
a means to keep track of physical exercises performed by the person (user).

2. An apparatus of claim 1, further comprising:
a means to enter data on date, food items consumed, amount of each food item consumed, caloric and nutrient values of the food items consumed; physical exercises performed, duration of each physical exercise, calories burned in each exercise; sex, age, height, weight and body frame of the person (user);
a means to process the data entered over a desired time period;
a means to present the processed data in various formats like tables, bar-graphs and pie-charts.

3. An apparatus of claim 2, wherein the means to enter data is a stylus or a keypad or a UPC symbol scanner connected to the apparatus or a voice command or a combination there of.

4. An apparatus of claim 2, further comprising a built-in data base: on caloric and nutrient values of food items served in restaurants, sold in stores and prepared at home; on calorie burning rate of physical exercises; on desirable weights for different height and body-frame combinations, on percentage of U.S. recommended daily allowances, on various diets, such as, Pritikin diet, low-fat diet, 600-calorie diet, and 1000-calorie diet; on nutrient calorie ratios of common food items consumed; nutrient comparison charts for various food items; and on answers to frequently asked questions on diet and physical exercise.

5. An apparatus of claim 1, further comprising means of automatically calculating the food items consumed into equivalent calories or amounts of various nutrients or both, and individual percentage caloric value of each nutrient in the food consumed with respect to total caloric value, and physical exercises performed into equivalent calories burned.

6. An apparatus of claim 5, further comprising means to perform calorie balance analysis or nutrient content balance analysis or both by comparing the calculated value of the calories or the nutrient in the food consumed with a budgeted calorie in-take or the nutrient in-take prescribed by a health professional or calculated by the apparatus itself based on attributes such as the person's sex, age, height, weight, and body-frame.

7. An apparatus of claim 6, further comprising a means to come-up with a dietary or a physical exercise recommendation if the calorie balance or the nutrients balance or both is/are positive or negative.

8. An apparatus of claim 4, further comprising a means to self correct the built-in data base based on the food items consumed, physical exercise, and user weight data entered continually over a specified time period.

9. An apparatus of claim 4, further comprising a means to get connected to a computer in order to dial-up to a web-site to upgrade the built-in data base and software, to send selected information electronically to a health professional if desired, and to print the data.

10. An apparatus of claim 6, further comprising alerting features like audible alarm or beeper or vibration or a combination of these features: to remind the person (user) over a specified interval to enter the data on food items consumed and physical exercises performed, and also to alert the person whenever the calories in-take or the nutrient in-take exceed their budgeted values.

11. An apparatus of claim 2, further comprising a means to present information on type of the food items consumed or type of the physical exercise performed or both in the past over a specified period of interest including the date, description of food items consumed, the amount of each food item consumed, equivalent calorie amount of the food items, amount of each nutrient in the food consumed, description of physical exercise performed, duration of exercise, and calories burned.

12. An apparatus of claim 1, further comprising means to keep track of food items consumed and physical exercises performed by more than one person.

13. An apparatus of claim 1, further comprising means to get integrated with a calculator, a telephone, an organizer, a radio, or a CD/casette player.

14. An apparatus of claim 1, further comprising:
a means of comparing physical exercise calories burned with a budgeted physical exercise calories burnout; and
a means to come up with a physical exercise recommendation if exercise calories balance is positive.

15. An apparatus of claim 1, further comprising:
a display to facilitate inputting of data, viewing of processed data and databases in the gadget.
